(19) United States
(12) Patent Application Publication
(10) Pub. No.: US 2013/0088350 A1
(43) Pub. Date: Apr. 11, 2013

(54) WIND-POWERED ALARM ANEMOMETER

(71) Applicant: William M. STEIN, Amherst, MA (US)

(72) Inventor: William M. STEIN, Amherst, MA (US)

(21) Appl. No.: 13/632,458

(22) Filed: Oct. 1, 2012

Related U.S. Application Data
(60) Provisional application No. 61/543,438, filed on Oct. 5, 2011.

(51) Int. Cl. G08B 21/18; G08B 1/08

(52) U.S. Cl. 340/539.1; 340/606; 340/679

(57) ABSTRACT

A wind-powered anemometer generates sufficient electrical energy to monitor its rotational speed and to provide an alarm when the rotational speed exceeds a predetermined set point value. The anemometer includes an electrical generator and a signal conditioning system. An alarm is provided to enunciate when a dangerous condition is present.

### CROSS-REFERENCE TO RELATED APPLICATIONS

This application claims priority to and the benefit of co-pending U.S. provisional patent application Ser. No. 61/543,438, filed Oct. 5, 2011, which application is incorporated herein by reference in its entirety.

### TECHNICAL FIELD

This invention relates to anemometers.

### BACKGROUND

Many industries currently require accurate measurement of wind velocities. Measurements of wind velocity are currently performed by several different types of sensors or transducers. The most common type is the cup anemometer. Other types include propeller anemometers, sonic anemometers and most recently sodar and lidar anemometers, which are similar to radar in their principal of operation.

Anemometry is used for many purposes in addition to the obvious use as a weather instrument. Wind measurements are taken to determine sound and dispersion patterns. Measurements are taken to determine safety on highways and bridges. A major use of wind measurements is for the wind-power industry, for dispatch and control of wind farms. Another major use of anemometers is to insure the safe operation of cranes and lift systems. Lift systems are designed specifically for raising personnel for working at elevated heights.

All current portable anemometers require vigilance for observing in-situ wind speeds. These anemometers determine wind speed by virtue of an operator holding the anemometer in their hands and viewing on a meter or digital display the current wind speed. More often than not, the anemometer's electronics requires batteries to power the anemometer's measurement and display.

Therefore, an anemometer that overcomes these and other disadvantages is desired.

### SUMMARY

According to one aspect, the invention features a wind-powered anemometer. The wind-powered anemometer comprises a wind-reacting device; a rotatable shaft in mechanical communication with the wind-reacting device; an ac generator in mechanical communication with the rotatable shaft, the ac generator configured to produce an ac voltage that is monotonic with respect to the speed of wind applied to the wind-reacting device; and a signal conditioning and alarm circuit in electrical communication with the ac generator, the alarm circuit configured to provide an alarm signal when the speed of wind applied to the wind-reacting device exceeds a predetermined set point.

In one embodiment, the wind-reacting device is selected from the group consisting of a rotatable cup, a propeller, an impeller, and a savonious rotor.

In another embodiment, the ac generator comprises an armature fixedly attached to the shaft, the armature configured to rotate with the shaft; a plurality of magnets attached to the armature; a stator/circuit board fixedly located adjacent to the armature; and a plurality of coils located on the stator/circuit board, the stator/circuit board and the plurality of coils being free of magnetic material.

In yet another embodiment, the ac voltage that is monotonic with respect to the speed of wind applied to the wind-reacting device is an ac voltage that is generally directly proportional to the speed of wind applied to the wind-reacting device.

In a further embodiment, the signal conditioning and alarm circuit comprises a rectifier, a voltage limiter, a comparator, an oscillator and an alarm.

In still another embodiment, the comparator comprises a phase locked loop.

In yet another embodiment, the comparator comprises a reference voltage source and an operational amplifier.

In another embodiment, the alarm circuit comprises a low power microprocessor based microcontroller. The microcontroller consists of self-contained flash memory for program storage, a timer/counter circuit for measuring the generator output frequency, an analog to digital (A/D) converter for measuring the generator output voltage, and general purpose outputs for supplying control signals to the audible alarm.

According to another aspect, the invention relates to a wind-powered anemometer. The wind-powered anemometer comprises a fixed portion configured to be held in a substantially stationary location and a rotatable portion, the rotatable portion and the fixed portion connected by one or more bearings. The rotatable portion comprises a plurality of conic cups; a rotatable cap fixedly attached to the plurality of conic cups; a shaft fixedly attached to the rotatable cap; an armature fixedly attached to the shaft; and a plurality of magnets located on the armature. The fixed portion comprises a shaft housing; an electronics housing fixedly attached to the shaft housing; a stator/circuit board located within the electronics housing, fixedly attached to the electronics housing; a plurality of coils located on the stator in proximity to the plurality of magnets on the armature; and an alarm in communication with the signal conditioning electronics, the alarm configured to provide an alarm signal when a rotational speed of the shaft exceeds a predetermined set point.

In still another embodiment, the electronics housing is weatherproof.

In a further embodiment, the wind-powered alarm anemometer further comprises a removable bottom removably attached to the anemometer housing; and a mounting fixture located on the removable bottom, and configured to be attachable to an object and thereby allow for the mounting of the wind-powered alarm anemometer.

In yet another aspect, the invention relates to a wind-powered alarm anemometer system. The wind-powered alarm anemometer system comprises one or more wind-powered anemometers, each wind-powered anemometer comprising a wind-reacting device; a rotatable shaft in communication with the wind-reacting device; an ac generator in communication with the rotatable shaft, the ac generator configured to produce an ac voltage monotonic with respect to the speed of wind applied to the wind-reacting device; a signal conditioning and alarm circuit in communication with the ac generator, the alarm circuit configured to provide an alarm signal when an alarm condition exists; a wireless transmitter configured to transmit the alarm signal to a remote location; and an alarm receiver station located remotely from at least one of the one or more wind-powered anemometers, the alarm receiver station configured to provide a signal to a user indicating the presence of the alarm condition.

In yet a further embodiment, the ac voltage that is monotonic with respect to the speed of wind applied to the wind-reacting device is an ac voltage that is generally directly proportional to the speed of wind applied to the wind-reacting device.

In an additional embodiment, an alarm condition is the condition that the speed of wind applied to the wind-reacting device exceeds a predetermined set point.

The disclosed invention relates to a wind-powered anemometer with integral audible alarm comprising: a wind-reacting device; a rotatable shaft in communication with the wind-reacting device; an ac generator in communication with the rotatable shaft, and where the ac generator is configured to produce an ac voltage that is generally directly proportional to wind speed detected by the wind-reacting devices; a signal conditioning circuit in communication with the ac generator; and where the signal conditioning and circuit is configurable to activate an audible alarm, and where the signal conditioning and alarm circuit is supplied with power from the ac generator.

The disclosed invention also relates to a wind-powered anemometer comprising: a plurality of conic cups; a rotatable cap fixedly attached to the plurality of conic cups; a shaft fixedly attached to the rotatable cap; a shaft housing rotatably attached to the shaft, and configured such that the shaft rotates with respect to the shaft housing and the shaft housing remains stationary; a first bearing in communication with the shaft and the shaft housing; an electronics housing fixedly attached to the shaft housing; an armature located within the electronics housing and fixedly attached to the shaft; a stator/circuit board located within the electronics housing, fixedly attached to the electronics housing, rotatably attached to the shaft, and configured such that shaft rotates with respect to the stator and the stator remains stationary; a top side of the stator facing the armature; an under side of the stator facing away from the armature; a plurality of coils located on the stator; a plurality of magnets located on the top side of the armature; a second bearing in communication with the shaft and the stator/circuit board, and configured to allow the shaft to rotate with respect to the stator/circuit board.

The invention also relates to a wind-powered anemometer system comprising: a wind-reacting device; a rotatable shaft in communication with the wind-reacting device; an ac generator in communication with the rotatable shaft, and where the ac generator is configured to produce an ac voltage that is generally directly proportional to wind speed measured by the wind-reacting device; a signal conditioning circuit in communication with the ac generator; and a signal conditioning and alarm circuit.

### BRIEF DESCRIPTION OF THE DRAWINGS

The present disclosure will be better understood by those skilled in the pertinent art by referencing the accompanying drawings, where like elements are numbered alike in the several figures, in which:

FIG. 1 is a perspective view of an anemometer;

FIG. 2A and FIG. 2B illustrate components of the anemometer of FIG. 1, with the base removed;

FIG. 3 is a cross-sectional view of a disclosed AC generator;

FIG. 4A is a schematic diagram of the electronics required to detect specific wind speeds, to compare those wind speeds to a set point signal and to initiate the sounding of the audible alarm of the disclosed anemometer system;

FIG. 4B is a schematic of another embodiment of the electronics required to detect specific wind speeds, to compare those wind speeds to a set point signal and to initiate the sounding of the audible alarm of the disclosed anemometer system;

FIG. 4C is a schematic of yet another embodiment of the electronics required to detect specific wind speeds, to compare those wind speeds to a set point signal and to initiate the sounding of the audible alarm of the disclosed anemometer system;

FIG. 5 is a cross-sectional view of a disclosed anemometer;

FIG. 6 is a plan view of the generator armature assembly;

FIG. 7 is a plan view of the generator stator assembly; and

FIG. 8A through FIG. 8D are graphs showing the calibration of four anemometers constructed according to principles of the invention, which exhibit monotonically increasing frequency signals as wind speed increases. For some devices the frequency is essentially linear with wind speed.

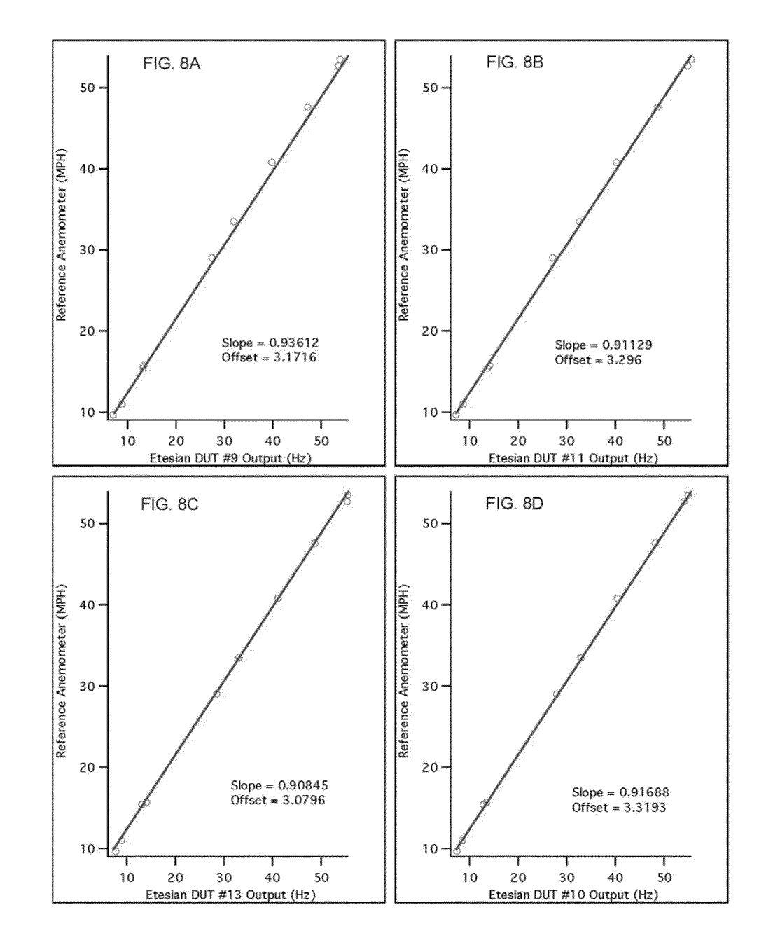

### DETAILED DESCRIPTION

This disclosure contemplates wind-powered anemometers that include warning alarms in the advancement of public safety. State-of-the-art microelectronics has made possible small, low power, signal conditioning and audible alarms. Anemometers that operate according to principles of the invention can eliminate the necessity of constantly viewing the anemometer by inclusion of an audible and/or visual alarm. Anemometers that operate according to principles of the invention can use the anemometer powered by the very wind that is being measured to provide electrical power, thereby ensuring convenience in use, and eliminating of the problem of replacement of discharged or dead batteries.

This invention is the realization that a conventional mechanical transducer anemometer is not only a transducer for determining wind velocity, but is also a tiny wind turbine power plant, capable of powering signal conditioning circuitry, and an audible alarm.

In its simplest form, the disclosed wind-powered alarm anemometer can be used as a permanently mounted anemometer for personnel lifting platforms. The anemometer has an adjustable set point for determining the wind speed at which the alarm sounds. Upon a wind speed exceeding the set point the audible alarm sounds, warning the operator of unsafe conditions. In other embodiments, the anemometer can be used in conjunction with other structures.

### Theoretical Power in a Cross Section of Wind

To show the general magnitude of energy in the wind available from a small cross section, a table of energy associated with wind speed for a small area is provided below. In this example a cross-sectional area based upon a 6 inch diameter is used. The power available is proportional to the cube of the wind speed.

| Pwr (mW) | radius (ft) | wind speed (mph) |
|---|---|---|
| 1.040125 | 0.25 | 1 |
| 8.321 | 0.25 | 2 |
| 66.568 | 0.25 | 4 |
| 532.544 | 0.25 | 8 |
| 4260.352 | 0.25 | 16 |
| 34082.816 | 0.25 | 32 |

Note that this is the energy available in the wind. Any practical device will deliver less. A typical modern wind turbine might capture as much as 35 to 40% of the energy content in the wind. The disclosed wind-powered alarm anemometer may be expected to deliver about 10% to about 20% of the energy in the wind. Using a conservative 10% power coefficient, the power available at 8 mph, would be approximately 50 mW.

Measured Power from a Typical Anemometer

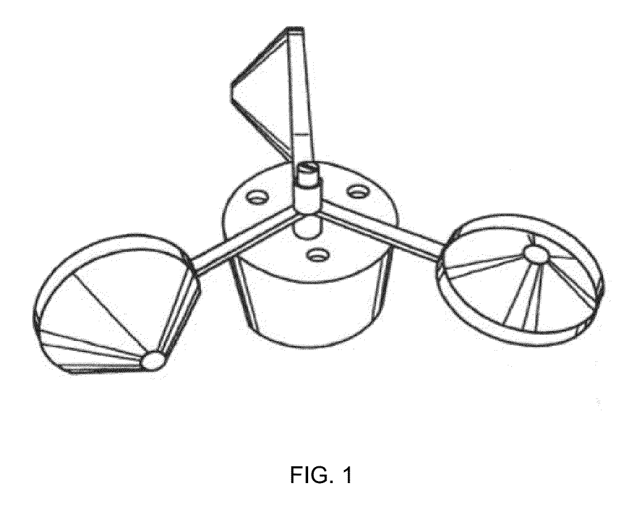

One of the workhorses of the wind-power industry is the Maximum #40 anemometer available from NRG SYSTEMS, 110 Commerce Street, Hinesburg, Vt. 05461. It is shown in FIG. 1. The Maximum #40 anemometer is a typical drag cup type anemometer. The transfer function for this anemometer is represented by the following equation:

MPH=(Hz×1.711)+0.78

where MPH represents wind speed in miles per hour and Hz is the output frequency of the four pole anemometer's ac generator.

Note that the Maximum #40 anemometer has three rotating cups. The cups rotate on an axle, and attached to the axle inside the body of the anemometer is a small round magnet, approximately 1 inch in diameter, by ½ inch thick. Located near the magnet, in a position to intercept magnetic flux changes as the magnet rotates is a single coil of many turns. This coil and magnet is the basis for an AC generator suitable for providing a sinusoidal AC signal suitable for input to data loggers and readouts when connected by a pair of conducting wires. This signal is far too small to provide useful power.

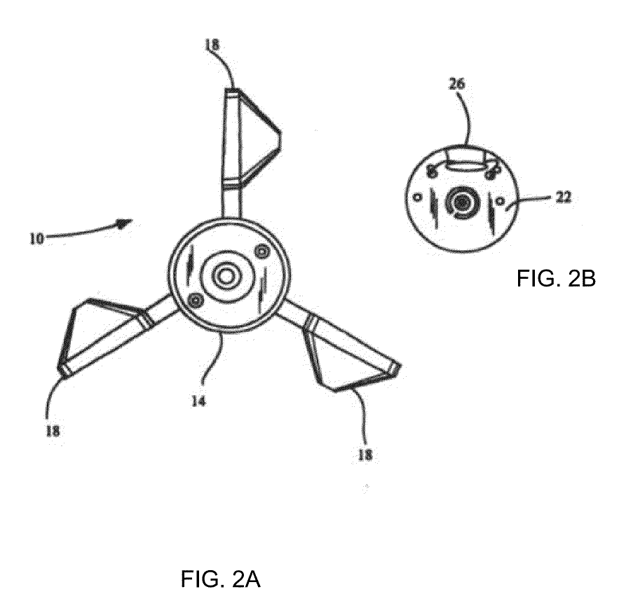

The internal construction of the Maximum #40 anemometer is shown in FIG. 2A and FIG. 2B. In FIG. 2A a drag cup assembly 10 is shown. At its center is a circular magnet 14. The circular magnet 14 spins with the cups 18. FIG. 2B illustrates a base 22 which may hold a single coil 26.

The output of the Maximum #40 was measured with a digital storage oscilloscope (DSO), at 3 wind speeds and the data indicates that the voltage is approximately linear with frequency. Below is a table that summarizes the data from the oscilloscope capture.

| Hz | wind speed | millivolts (p-p) |
|---|---|---|
| 6.0 | 11.0 | 90.00 |
| 12.9 | 22.9 | 200.00 |
| 18.9 | 33.1 | 280.00 |

The anemometer as a generator can be modeled as a voltage source with a series impedance. The resistive component may be about 650 ohms at RT, indicative of the length of the coil of wire used to make the AC generator. Optimal power transfer will occur with a load resistance of about 650 ohms. With this load it is expected that half the source voltage to be delivered to the load.

The power available would be given by P=V²/R, where P is power, V is voltage in volts and R is resistance in ohms. At the three measured wind speeds the power available is shown in the table below:

| mVrms | resistance | Pwr (mW) |
|---|---|---|
| 63.63 | 650 | 6e⁻⁶ |
| 141.4 | 650 | 3.1e⁻⁵ |
| 197.96 | 650 | 5.97e⁻⁵ |

The unmodified anemometer provides very little power, too little even for use with very low power design electronics. Therefore, in one embodiment of the disclosed wind-powered alarm anemometer there was added a second coil and added iron to the magnetic circuit. By doing this an increase in the power available was obtained. The available power was about 1 mw at 20 mph.

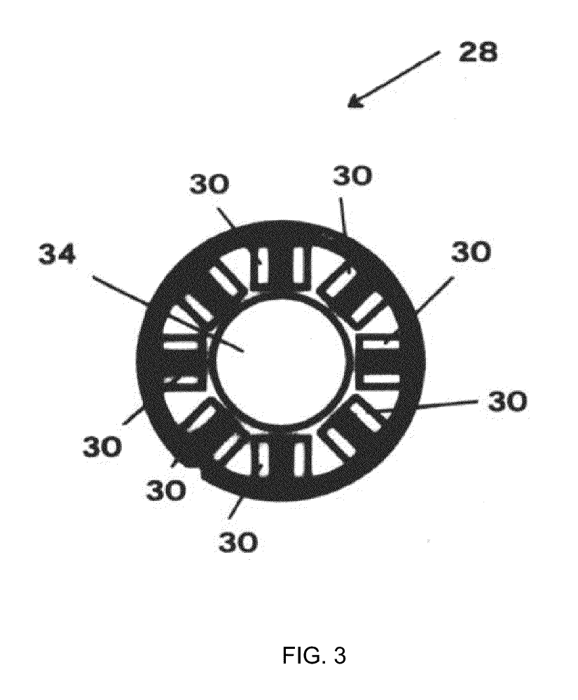

By altering the magnetic circuit and windings a suitable generator can be created, in the same mechanical envelope of the base, which will deliver enough power to the signal conditioning and alarm. One embodiment of an AC generator 28 for use in the disclosed wind-powered alarm anemometer is pictured in FIG. 3. In a preferred embodiment, the AC generator may have eight coils 30 evenly spaced around a circular four pole magnet 34. In a preferred embodiment, the coils may be wound on plastic bobbins. In a preferred embodiment, the magnet may comprise a stack of silicon steel laminations, each lamination approximately circular, with about 8 teeth, each bobbin placed on a tooth. In a preferred embodiment, the air gap is intentionally large to minimize cogging, so that the anemometer may respond to low wind velocities.

Power Consumption from the Circuitry

In a preferred embodiment, the circuitry used in the disclosed wind-powered alarm anemometer may comprise a phase/frequency detector, a local oscillator, a low duty cycle free running oscillator and an audible alarm. In some embodiments, the audible alarm is a piezoelectric enunciator.

### Signal Conditioning and Alarm Triggering

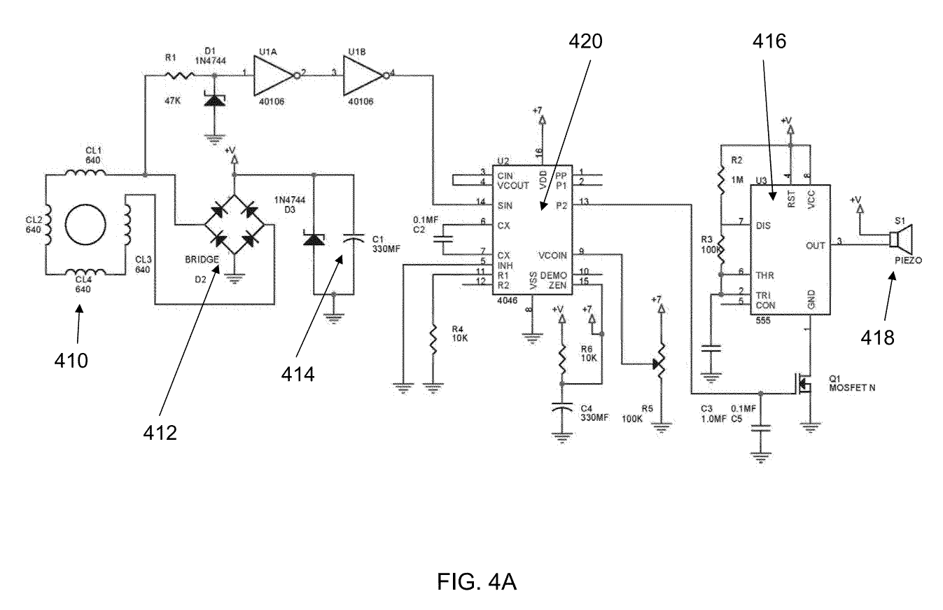

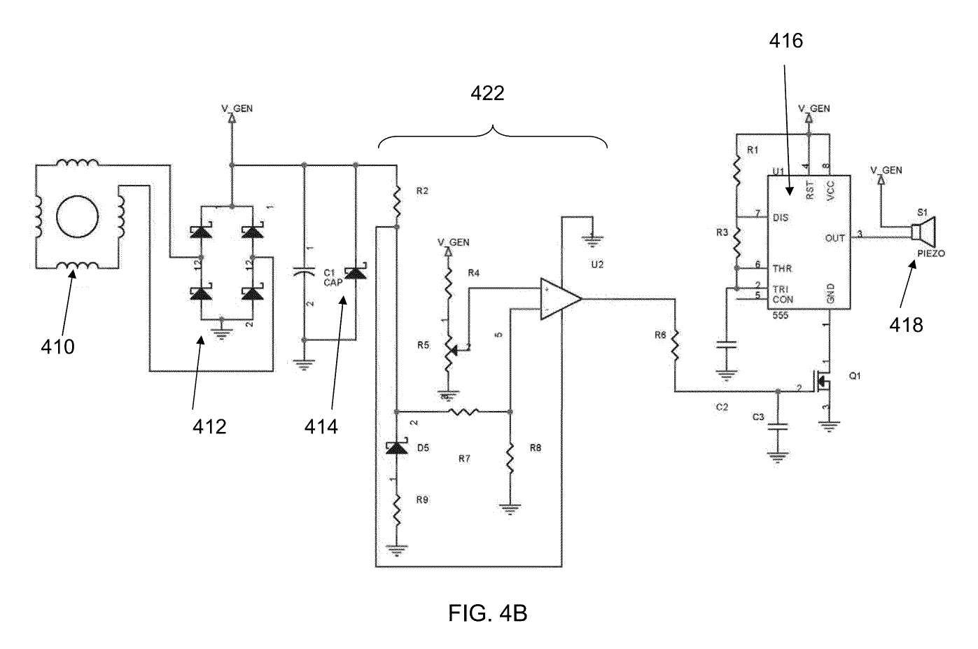

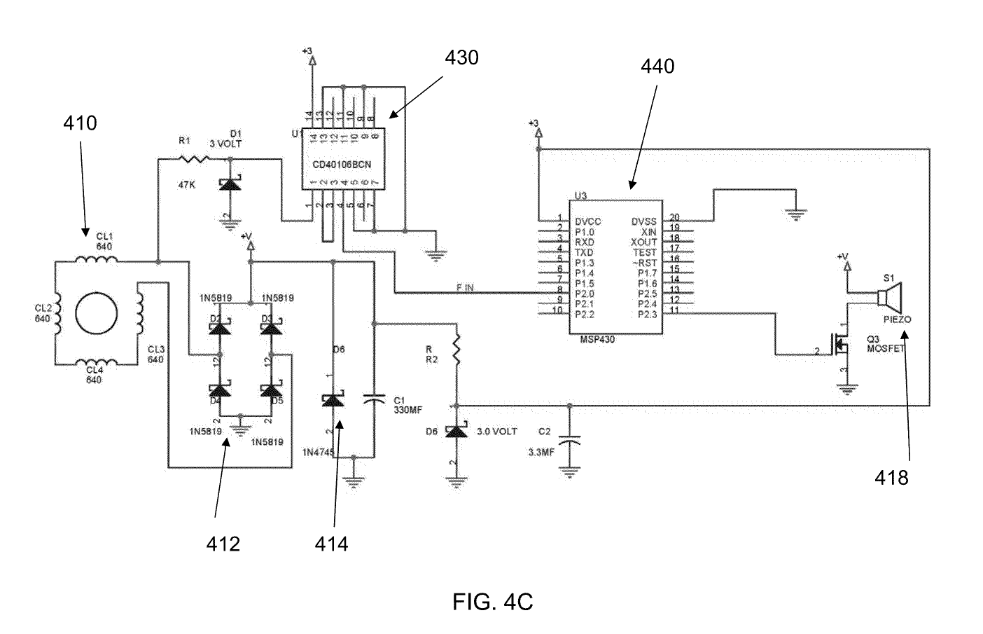

FIG. 4A is a schematic of one embodiment of the electronics required to detect specific wind speeds, to compare those wind speeds to a set point signal and to initiate the sounding of the audible alarm. The electronics are small, can be assembled on a circuit board, and can be housed in the anemometer body. The audible alarm enunciator 418 is housed within the anemometer body. In a preferred embodiment an opening for the sound energy to be emitted is provided.

Referring to FIG. 4A, a generator 410 is powered by a wind-reacting device, and provides an output signal when operating. The generator output is connected to a bridge rectifier 412, comprising four diodes referenced as D2. This provides a rectification to DC for powering the signal conditioning. This diode rectified AC is then filtered by capacitor 414 C1.

A Zener diode, D3, prevents overvoltage by limiting the voltage to about 15 volts, under any condition of generator output.

The generator output is also connected to a single Zener diode, D1, so as to be presented to a Schmidt trigger, U1A and U1B. The Schmidt trigger insures that a square wave with a fast rising edge is presented to a frequency comparator 420, embodied in semiconductor chip U2, for example a HEF4046B phase locked loop available from NXP Semiconductors. In one embodiment, the Schmidt trigger is provided using two inverting buffer stages of a hex inverting buffer chip. The Schmidt trigger converts the Zener diode half wave rectified sinusoidal voltage, into a square wave of the same frequency. The U2 frequency comparator output signal provides the gating signal to Q1. Q1 is therefore in conduction when the AC generator frequency exceeds U2's adjustable internal reference oscillator.

Semiconductor chip 416 U3 is a low power CMOS implementation of a “555 timer” a mono stable multivibrator connected for operation as a low duty cycle oscillator. Q1 completes the powering of the 555 timer. When powered the 555 timer delivers approximately a 20% duty cycle drive to the 3 kHz piezoelectric alarm 418, therefore sounding the well known warning chirp, alerting the user to unsafe conditions.

FIG. 4B is a schematic of another embodiment of the electronics required to detect specific wind speeds, to compare those wind speeds to a set point signal and to initiate the sounding of the audible alarm. The electronics are small, and will be housed in the anemometer body. An opening for the sound energy to be emitted is required. In an alternative, a signal can be transmitted to a remote receiver, where the alarm is situated, for example at a control station remote from the wind-reacting device.

As shown in FIG. 4B, a generator 410 is powered by a wind-reacting device, and provides an output signal when operating. The generator output is connected to a bridge rectifier 412, comprising four diodes. This provides a rectification of the AC generator output to a DC signal for powering the signal conditioning. This DC signal is then filtered by capacitor 414 C1.

A Zener diode 414, D3, prevents overvoltage by limiting the voltage to about 17 volts, under any condition of generator output.

The generator output is also connected to comparator 422. The comparator 422 includes a potentiometer R5, and resistor R4 to scale the output of the anemometer generator voltage which is linear and in direct relationship to the anemometer rotational velocity, also linear and in direct relationship to the wind speed. In the comparator 422, this voltage is then compared by U2 to the fixed reference voltage derived from a precision reference diode D5. When the potentiometer R5 voltage exceeds the reference voltage from D5, the comparator U2 output is high. This provides a gate drive voltage to Q1, enabling the operation of U1 as is now described.

Chip U1 416 is a low power CMOS implementation of a “555 timer” a mono stable multivibrator connected for operation as a low duty cycle oscillator. This low duty cycle operation delivers the drive signal to S1. The 555 timer delivers approximately a 20% duty cycle drive at about 1 second intervals (1 Hz) to the 3 kHz piezoelectric alarm 418, therefore sounding the well known warning chirp, alerting the user to unsafe conditions.

FIG. 4C is a schematic of yet another embodiment of the electronics required to detect specific wind speeds, to compare those wind speeds to a set point signal and to initiate the sounding of the audible alarm. The electronics are small, and will be housed in the anemometer body. An opening for the sound energy to be emitted is required. In an alternative, a signal can be transmitted to a remote receiver, where the alarm is situated, for example at a control station remote from the wind-reacting device.

As shown in FIG. 4B, a generator 410 is powered by a wind-reacting device, and provides an output signal when operating. The generator output is connected to a bridge rectifier 412, comprising four diodes. This provides a rectification of the AC generator output to a DC signal for powering the signal conditioning. This DC signal is then filtered by capacitor 414 C1.

A Zener diode 414, D3, prevents overvoltage by limiting the voltage to about 17 volts, under any condition of generator output.

The generator output is also connected to pulse generator 430. This can be implemented using a Hex Schmitt Trigger, such as a CD40106BCN chip available from Fairchild Semiconductor Corporation, 82 Running Hill Road, South Portland, Me. 04106 U.S.A. The pulse generator 430 provides a series of square wave pulses that are proportional to the rotation frequency of the generator 410.

The pulses are sent to a microprocessor, which can be programmed with instructions recorded on a machine readable memory. In the embodiment illustrated, the microprocessor is a MSP430™ Ultra-Low Power 16-Bit Microcontroller available from Texas Instruments, 12500 TI Boulevard, Dallas, Tex. 75243 USA, although other microprocessors or microcontrollers could also be employed. The microcontroller compares the incoming pulses to data recorded in memory, and if an alarm condition is identified, the microprocessor generates an alarm signal. The alarm signal can be coded to provide an audible signal representative of a specific alarm condition. The alarm signal is sent to a piezoelectric alarm 418, if an audible alarm is needed. In other embodiments, an alarm signal representative of an alarm condition can be encoded and sent to some other type of enunciator, for example a visual enunciator such as a display. If no alarm condition exists, the visual display might be provided with a signal that indicates normal operation.

### Alternative Embodiment

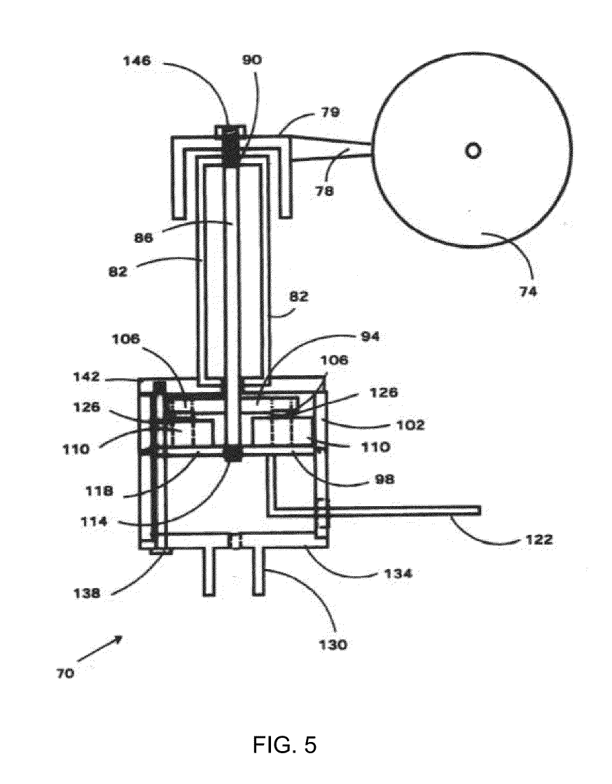

FIG. 5 is a cross-sectional view 70 of an embodiment of the disclosed wind-powered wireless anemometer. A conic cup 74 is shown attached to a rotatable cap 79. Although only one conic cup 74 is shown, there may be 3, 4 or more conic cups attached to the rotatable cylindrical cap via a cup arm 78. The conic cup 74 may have an outer diameter of about 2.5 inches and be about 1 inch deep. Of course, the conic cup 74 may be sized differently based on differing conditions, locations, etc. Such differently sized cups 74, are still be within the scope of this disclosure. The conic cups 74 are the wind-reacting device of the anemometer. The cap 79 is fixedly attached to a shaft 86. A first bearing 90 is in communication with the shaft 86 and the shaft housing 82, and allows the shaft 86 and the cap 79 to rotate with respect to the housing 82. The shaft is fixedly attached to an armature 94. A stator 98 is located adjacent to the armature 94. On the under side 118 of the stator 98 is located the signal conditioning circuits described with respect to the circuit illustrated in FIG. 4. In some embodiments, the stator 98 may be made out of circuit board material. In other embodiments, the stator 98 is separate from the circuit board that supports the circuitry of FIG. 4. The coils 110 may be affixed to the top of the circuit board, with the other electronic components affixed to the bottom of the circuit board. This stator/circuit board configuration may be referred to as a “stator/circuit board 98”. The stator/circuit board 98 is fixedly attached to an electronics housing 102. The armature has a plurality of magnets 106 distributed about the center of the armature 94. The armature 94 is configured to rotate with the shaft 86. The magnets 106 are located adjacent to and in close proximity to the coils 110 and are configured to rotate with the armature 106 such that the rotating magnets 106 and stationary coils 110 work together as an AC generator. In one embodiment, there is an air gap 126 between the coils 110 and the magnets 106 of about 0.025 inches. The shaft 86 is in communication with a second bearing 114. The second bearing is attached to the stator/circuit board 98. The shaft is able to rotate in the first and second bearings 90, 114. In one embodiment the shaft 86 is about 4 inches long.

In some embodiments, the electronics housing 102 may have a removable bottom shield 134. In some embodiments, the electronics housing 102 may be a weatherproof housing to protect the electronics and other components within the housing. In some embodiments, the electronics housing 102 may have a mounting fixture 130. In some embodiments, the removable bottom shield 134 may be held in place by any convenient attaching means, such as one or more screws 138. Only one of four screws is shown in the embodiment illustrated in FIG. 5. In some embodiments, the screw(s) 138 may be threaded into a bottom side of the top 142 of the electronics housing 102. In some embodiments, the shaft 86 may be threaded on its upper end 146. In some embodiments, a nut 150 may be used to attach the shaft 86 to the rotatable cap 79. In some embodiments, the cap 79 may also be threaded for attachment to the shaft 86.

The stator/circuit board 98 and the coils 110 may be manufactured such they have generally very little magnetic material, such as but not limited to iron, or they may contain no magnetic material whatsoever. This lack of magnetic material such as iron prevents the magnets 106 from being magnetically attracted to the coils 110 or stator/circuit board 98, thus allowing for a greater rotational freedom of the armature 94 with respect to the stator/circuit board 98. The freedom of rotation allows for the disclosed anemometer to measure wind speeds of very low magnitude.

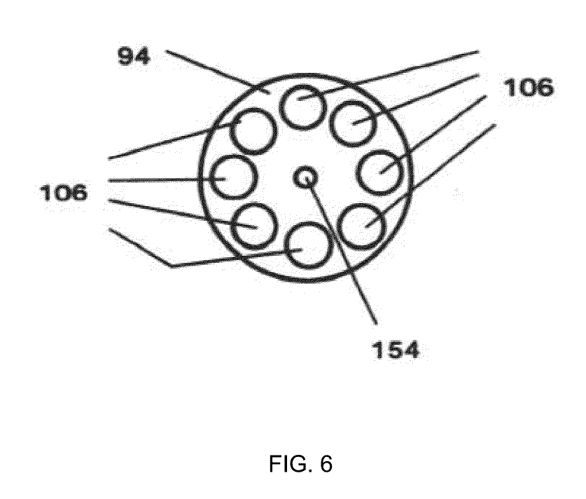

FIG. 6 is a plan view of the armature 94. The armature 94 has a generally circular shape. The armature 94 has a plurality of magnets 106 attached to it. These magnets 106 may also have a circular shape, but magnets of a shape other than circular can also be used. The armature 94 has defined therein an opening 154 where the shaft 86 attaches to the armature 94. The shaft 86 may be attached to the armature 94 by any convenient means, including but not limited to gluing, welding, or press fitting. In some embodiments, the armature may have an outer diameter of about 1.75 inches. In some embodiments, the magnets may be about ⅜ inch long, and about ⅜ inch in diameter.

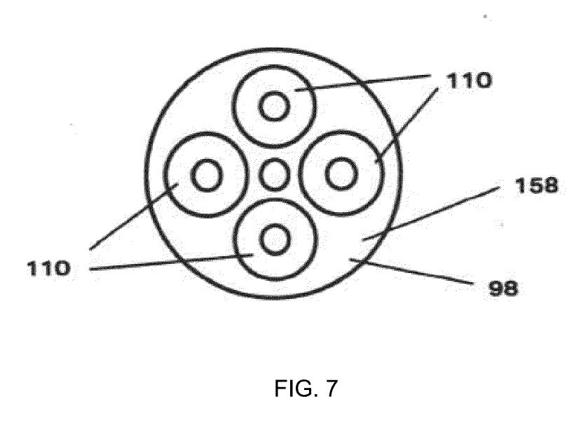

FIG. 7 is a plan view of the stator/circuit board 98. The stator/circuit board 98, which may be made out of circuit board material, has a plurality of coils 110 on its top side 158. Not visible in this view, is the underside 118 of the stator/circuit board and the electronic components, which comprise the circuit board discussed with respect to FIG. 4, may be attached to the underside 118. In other embodiments, a circuit board with the electronic components may be attached to the underside 118 of a separate stator 98, and the coils 110 attached to the top side 158 of the separate stator 98. An opening 162 is defined in the center of the stator/circuit board 98. The opening 162 is configured to hold a bearing 114. The bearing 114 allows the shaft 86 to rotate while the stator/circuit board remains stationary. In some embodiments, the stator/circuit board 98 has a generally circular shape. The coils 110 also have a generally circular shape. In some embodiments, the stator/circuit board may have an outer diameter of about 2 and 3/16 inches. In some embodiments, the coils may have about a ¾ inch outer diameter, and about a ¼ inch inner diameter.

It will be apparent to one of ordinary skill in the art that any mechanical anemometer configuration suitable for driving a small generator is encompassed by this disclosure. The disclosed invention may be easily modified to be usable with many types of anemometer, including, but not limited to a rotatable cup anemometer, a propeller anemometer, an impeller anemometer, and a savonious rotor anemometer. In general, any anemometer that rotates would be suitable for inclusion of a generator and ultra low power electronics for wireless transmission. Additionally, a DC generator may be used instead of an AC generator.

### Additional Embodiments

It is also possible to provide a wireless system that announces an alarm condition at a remote location.

Any dimensions used in this paper are for illustrative purposes, and other values for the given dimensions may be used and still be within the scope of the disclosed invention.

### DEFINITIONS

As used herein, the term “wind-reacting device” is intended to mean a device that reacts to an applied stream of air, such as a wind, by providing a mechanical response, such as rotation at an angular velocity that is monotonic with respect to the speed of the wind. Examples of wind-reactive devices are a rotatable cup, a propeller, an impeller, and a savonious rotor.

Recording the results from an operation or data acquisition, such as for example, recording results at a particular frequency or wavelength, is understood to mean and is defined herein as writing output data in a non-transitory manner to a storage element, to a machine-readable storage medium, or to a storage device. Non-transitory machine-readable storage media that can be used in the invention include electronic, magnetic and/or optical storage media, such as magnetic floppy disks and hard disks; a DVD drive, a CD drive that in some embodiments can employ DVD disks, any of CD-ROM disks (i.e., read-only optical storage disks), CD-R disks (i.e., write-once, read-many optical storage disks), and CD-RW disks (i.e., rewriteable optical storage disks); and electronic storage media, such as RAM, ROM, EPROM, Compact Flash cards, PCMCIA cards, or alternatively SD or SDIO memory; and the electronic components (e.g., floppy disk drive, DVD drive, CD/CD-R/CD-RW drive, or Compact Flash/PCMCIA/SD adapter) that accommodate and read from and/or write to the storage media. Unless otherwise explicitly recited, any reference herein to “record” or “recording” is understood to refer to a non-transitory record or a non-transitory recording.

As is known to those of skill in the machine-readable storage media arts, new media and formats for data storage are continually being devised, and any convenient, commercially available storage medium and corresponding read/write device that may become available in the future is likely to be appropriate for use, especially if it provides any of a greater storage capacity, a higher access speed, a smaller size, and a lower cost per bit of stored information. Well known older machine-readable media are also available for use under certain conditions, such as punched paper tape or cards, magnetic recording on tape or wire, optical or magnetic reading of printed characters (e.g., OCR and magnetically encoded symbols) and machine-readable symbols such as one and two dimensional bar codes. Recording image data for later use (e.g., writing an image to memory or to digital memory) can be performed to enable the use of the recorded information as output, as data for display to a user, or as data to be made available for later use. Such digital memory elements or chips can be standalone memory devices, or can be incorporated within a device of interest. “Writing output data” or “writing an image to memory” is defined herein as including writing transformed data to registers within a microcomputer.

“Microcomputer” is defined herein as synonymous with microprocessor, microcontroller, and digital signal processor (“DSP”). It is understood that memory used by the microcomputer, including for example instructions for data processing coded as “firmware” can reside in memory physically inside of a microcomputer chip or in memory external to the microcomputer or in a combination of internal and external memory. Similarly, analog signals can be digitized by a standalone analog to digital converter (“ADC”) or one or more ADCs or multiplexed ADC channels can reside within a microcomputer package. It is also understood that field programmable array (“FPGA”) chips or application specific integrated circuits (“ASIC”) chips can perform microcomputer functions, either in hardware logic, software emulation of a microcomputer, or by a combination of the two. Apparatus having any of the inventive features described herein can operate entirely on one microcomputer or can include more than one microcomputer.

General purpose programmable computers useful for controlling instrumentation, recording signals and analyzing signals or data according to the present description can be any of a personal computer (PC), a microprocessor based computer, a portable computer, or other type of processing device. The general purpose programmable computer typically comprises a central processing unit, a storage or memory unit that can record and read information and programs using machine-readable storage media, a communication terminal such as a wired communication device or a wireless communication device, an output device such as a display terminal, and an input device such as a keyboard. The display terminal can be a touch screen display, in which case it can function as both a display device and an input device. Different and/or additional input devices can be present such as a pointing device, such as a mouse or a joystick, and different or additional output devices can be present such as an enunciator, for example a speaker, a second display, or a printer. The computer can run any one of a variety of operating systems, such as for example, any one of several versions of Windows, or of MacOS, or of UNIX, or of Linux. Computational results obtained in the operation of the general purpose computer can be stored for later use, and/or can be displayed to a user. At the very least, each microprocessor-based general purpose computer has registers that store the results of each computational step within the microprocessor, which results are then commonly stored in cache memory for later use, so that the result can be displayed, recorded to a non-volatile memory, or used in further data processing or analysis.

Many functions of electrical and electronic apparatus can be implemented in hardware (for example, hard-wired logic), in software (for example, logic encoded in a program operating on a general purpose processor), and in firmware (for example, logic encoded in a non-volatile memory that is invoked for operation on a processor as required). The present invention contemplates the substitution of one implementation of hardware, firmware and software for another implementation of the equivalent functionality using a different one of hardware, firmware and software. To the extent that an implementation can be represented mathematically by a transfer function, that is, a specified response is generated at an output terminal for a specific excitation applied to an input terminal of a “black box” exhibiting the transfer function, any implementation of the transfer function, including any combination of hardware, firmware and software implementations of portions or segments of the transfer function, is contemplated herein, so long as at least some of the implementation is performed in hardware.

Although the theoretical description given herein is thought to be correct, the operation of the devices described and claimed herein does not depend upon the accuracy or validity of the theoretical description. That is, later theoretical developments that may explain the observed results on a basis different from the theory presented herein will not detract from the inventions described herein.

Any patent, patent application, patent application publication, journal article, book, published paper, or other publicly available material identified in the specification is hereby incorporated by reference herein in its entirety. Any material, or portion thereof, that is said to be incorporated by reference herein, but which conflicts with existing definitions, statements, or other disclosure material explicitly set forth herein is only incorporated to the extent that no conflict arises between that incorporated material and the present disclosure material. In the event of a conflict, the conflict is to be resolved in favor of the present disclosure as the preferred disclosure.

While the disclosure has been described with reference to several embodiments, it will be understood by those skilled in the art that various changes may be made and equivalents may be substituted for elements thereof without departing from the spirit and scope of the disclosure. In addition, many modifications may be made to adapt a particular situation or material to the teachings of the disclosure without departing from the essential scope thereof. Therefore, it is intended that the disclosure not be limited to the particular embodiments disclosed as the best mode contemplated for carrying out this disclosure, but that the disclosure will include all embodiments falling within the scope of the appended claims

What is claimed is:

1. A wind-powered anemometer, comprising:
a wind-reacting device;
a rotatable shaft in mechanical communication with the wind-reacting device;
an ac generator in mechanical communication with the rotatable shaft, the ac generator configured to produce an ac voltage that is monotonic with respect to the speed of wind applied to the wind-reacting device; and
a signal conditioning and alarm circuit in electrical communication with the ac generator, the alarm circuit configured to provide an alarm signal when the speed of wind applied to the wind-reacting device exceeds a predetermined set point.

2. The wind-powered alarm anemometer of claim 1, wherein the wind-reacting device is selected from the group consisting of a rotatable cup, a propeller, an impeller, and a savonious rotor.

3. The wind-powered anemometer of claim 1, wherein the ac generator comprises:
an armature fixedly attached to the shaft, the armature configured to rotate with the shaft;
a plurality of magnets attached to the armature;
a stator/circuit board fixedly located adjacent to the armature; and
a plurality of coils located on the stator/circuit board, the stator/circuit board and the plurality of coils being free of magnetic material.

4. The wind-powered anemometer of claim 1, wherein the ac voltage that is monotonic with respect to the speed of wind applied to the wind-reacting device is an ac voltage that is generally directly proportional to the speed of wind applied to the wind-reacting device.

5. The wind-powered anemometer of claim 1, wherein the signal conditioning and alarm circuit comprises a rectifier, a voltage limiter, a comparator, an oscillator and an alarm.

6. The wind-powered anemometer of claim 5, wherein the comparator comprises a phase locked loop.

7. The wind-powered anemometer of claim 5, wherein the comparator comprises a reference voltage source and an operational amplifier.

8. A wind-powered anemometer, comprising:
a fixed portion configured to be held in a substantially stationary location and a rotatable portion, the rotatable portion and the fixed portion connected by one or more bearings;
the rotatable portion comprising:
a plurality of conic cups;
a rotatable cap fixedly attached to the plurality of conic cups;
a shaft fixedly attached to the rotatable cap;
an armature fixedly attached to the shaft; and
a plurality of magnets located on the armature;
the fixed portion comprising:
a shaft housing;
an electronics housing fixedly attached to the shaft housing;
a stator/circuit board located within the electronics housing, fixedly attached to the electronics housing;
a plurality of coils located on the stator in proximity to the plurality of magnets on the armature; and
an alarm in communication with the signal conditioning electronics, the alarm configured to provide an alarm signal when a rotational speed of the shaft exceeds a predetermined set point.

9. The wind-powered alarm anemometer of claim 8, wherein the electronics housing is weatherproof.

10. The wind-powered alarm anemometer of claim 8, further comprising:
a removable bottom removably attached to the anemometer housing; and
a mounting fixture located on the removable bottom, and configured to be attachable to an object and thereby allow for the mounting of the wind-powered alarm anemometer.

11. A wind-powered alarm anemometer system, comprising:
one or more wind-powered anemometers, each wind-powered anemometer comprising
a wind-reacting device;
a rotatable shaft in communication with the wind-reacting device;
an ac generator in communication with the rotatable shaft, the ac generator configured to produce an ac voltage monotonic with respect to the speed of wind applied to the wind-reacting device;
a signal conditioning and alarm circuit in communication with the ac generator, the alarm circuit configured to provide an alarm signal when an alarm condition exists;
a wireless transmitter configured to transmit said alarm signal to a remote location; and
an alarm receiver station located remotely from at least one of said one or more wind-powered anemometers, said alarm receiver station configured to provide a signal to a user indicating the presence of said alarm condition.

12. The wind-powered alarm anemometer system of claim 11, wherein the ac voltage that is monotonic with respect to the speed of wind applied to the wind-reacting device is an ac voltage that is generally directly proportional to the speed of wind applied to the wind-reacting device.

13. The wind-powered alarm anemometer system of claim 11, wherein an alarm condition is the condition that the speed of wind applied to the wind-reacting device exceeds a predetermined set point.
